(19) United States
(12) Patent Application Publication
(10) Pub. No.: US 2026/0252940 A1
(43) Pub. Date: Aug. 27, 2026

(54) ACCURACY AND EFFICIENCY OF QUANTUM ERROR MITIGATION/CORRECTION TECHNIQUES ARE IMPROVED BY APPLYING A GAUGE TRANSFORMATION

(71) Applicants: International Business Machines Corporation, Armonk, NY (US); University of Chicago, Chicago, IL (US)

(72) Inventors: Edward Hong Chen, Apex, NC (US); Laurin Elias Fischer, Zürich (CH); Alireza Seif Tabrizi, Adelphi, MD (US); Liang Jiang, Chicago, IL (US); Senrui Chen, Chicago, IL (US)

(21) Appl. No.: 19/059,565

(22) Filed: Feb. 21, 2025

(51) Int. Cl. G06N 10/70; G06N 10/20

(52) U.S. Cl. CPC G06N 10/70; G06N 10/20

(57) ABSTRACT

A method, system, and computer program product for improving accuracy and efficiency of quantum error mitigation/correction techniques. A model (e.g., noise model) of a quantum gate set (collection of quantum gates) that accounts for SPAM and gate errors is built by running learning circuits at different depths with different initial states and measurements to extract information about the quantum system. A gauge transformation is then applied to the quantum gate set to transform both the SPAM and gate errors together. A gauge transformation enables a different perspective of the quantum system while still preserving the underlying physics. A quantum error mitigation/correction technique is then tailored to avoid interpreting errors (e.g., SPAM, gate errors, etc.) inconsistently if treated individually using the transformed SPAM and gate errors thereby requiring fewer additional circuit runs for accurate estimations which significantly reduces the computational overhead associated with quantum error mitigation/correction.

### TECHNICAL FIELD

The present disclosure relates generally to quantum error mitigation/correction, and more particularly to improving the accuracy and efficiency of quantum error mitigation/correction techniques by tailoring the technique to avoid interpreting errors (e.g., SPAM, gate errors, etc.) inconsistently if treated individually by applying a gauge transformation to a model of a quantum gate set that accounts for SPAM and gate errors.

### BACKGROUND

Quantum computing is a rapidly-emerging technology that harnesses the laws of quantum mechanics to solve problems too complex for classical computers. A quantum computer is a computer that exploits quantum mechanical phenomena. At small scales, physical matter exhibits properties of both particles and waves, and quantum computing leverages this behavior, specifically quantum superposition and entanglement, using specialized hardware that supports the preparation and manipulation of quantum states. Classical physics cannot explain the operation of these quantum devices, and a scalable quantum computer could perform some calculations exponentially faster than any modern “classical” computer.

Current quantum hardware, however, is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates,

As a result, quantum error mitigation and quantum error correction techniques have been developed. Quantum error mitigation refers to mitigating computation errors while keeping the hardware load to a minimum. That is, quantum error mitigation is a technique that reduces the effects of noise and errors on measured observables. Quantum error correction refers to a set of techniques used in quantum computing to protect quantum information stored in qubits from errors caused by noise and decoherence by encoding information across multiple physical qubits to detect and correct errors that may occur during computation.

Such techniques involve learning the noise of the quantum computer so that accuracy can be improved albeit at the expense of a longer experimental runtime. By learning the noise of the quantum computer, the noise present in the quantum computer can be understood and characterized, where such knowledge is utilized for designing strategies for detecting and correcting or mitigating errors that arise from that noise.

Unfortunately, there are inaccuracies in the learned noise model, such as due to state preparation and measurement (SPAM) errors and gate errors which can significantly impact the estimated noise characteristics. SPAM errors are additional noise sources that occur during the preparation of a quantum state and the measurement process, which can mask or distort the underlying gate errors, leading to misleading noise model estimations.

Currently, techniques to mitigate SPAM and gate errors use assumptions that introduce biases in quantum error mitigation/correction thereby reducing the accuracy of such techniques. Furthermore, due to such biases, the quantum error mitigation/correction techniques need to take more measurements (samples) to achieve the desired level of accuracy which significantly increases the overall runtime of the techniques. As a result of such biases and sampling overhead, the accuracy and efficiency of quantum error mitigation/correction techniques are negatively impacted.

### SUMMARY

In one embodiment of the present disclosure, a method for improving accuracy and efficiency of quantum error mitigation and quantum error correction techniques comprises building a model of a quantum gate set that accounts for state preparation and measurement (SPAM) errors and gate errors by running learning circuits at different depths with different initial states and measurements to extract information about a quantum system. The method further comprises applying a gauge transformation to the quantum gate set to transform both the SPAM errors and the gate errors together.

Furthermore, in one embodiment of the present disclosure, the method additionally comprises tailoring one of a quantum error mitigation technique and a quantum error correction technique to avoid interpreting the SPAM errors and the gate errors inconsistently using the transformed SPAM errors and gate errors.

Additionally, in one embodiment of the present disclosure, the learning circuits comprise depth-1 circuits where all quantum gates are applied in a single layer.

Furthermore, in one embodiment of the present disclosure, the method additionally comprises selecting an optimization objective based on one of a quantum error mitigation technique and a quantum error correction technique to be implemented. The method further comprises optimizing gauge parameters based on the optimization objective.

Additionally, in one embodiment of the present disclosure, the method further comprises applying the gauge transformation using the optimized gauge parameters to the quantum gate set to transform both the SPAM errors and the gate errors together.

Furthermore, in one embodiment of the present disclosure, the method additionally comprises applying the built model to a decoding technique.

Additionally, in one embodiment of the present disclosure, the decoding technique minimizes a logical error rate per syndrome round.

Other forms of the embodiments of the method described above are in a system and in a computer program product.

Accordingly, embodiments of the present disclosure improve the accuracy and efficiency of quantum error mitigation/correction techniques by improving the accuracy of the learned noise model and reducing the sampling overhead of the quantum error mitigation/correction techniques to achieve the desired level of accuracy.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for improving the accuracy and efficiency of a quantum error mitigation/correction technique by tailoring the technique to avoid interpreting errors (e.g., SPAM errors, gate errors, etc.) inconsistently if treated individually by applying a gauge transformation to a model of a quantum gate set that accounts for SPAM and gate errors in accordance with an embodiment of the present disclosure;

FIG. 3 illustrates a quasi-local noise model in accordance with an embodiment of the present disclosure;

FIG. 4 illustrates applying a gauge transformation using the optimized gauge parameters involving probabilistic error cancellation in accordance with an embodiment of the present disclosure;

FIG. 5 illustrates applying a gauge transformation using the optimized gauge parameters involving zero-noise extrapolation in accordance with an embodiment of the present disclosure;

FIG. 6 illustrates an embodiment of the present disclosure of the hardware configuration of the classical computer which is representative of a hardware environment for practicing the present disclosure; and

FIG. 7 is a flowchart of a method for improving the accuracy and efficiency of a quantum error mitigation/correction technique by tailoring the technique to avoid interpreting errors (e.g., SPAM errors, gate errors, etc.) inconsistently if treated individually by applying a gauge transformation to a model of a quantum gate set that accounts for SPAM and gate errors in accordance with an embodiment of the present disclosure.

### DETAILED DESCRIPTION

In one embodiment of the present disclosure, a method for improving accuracy and efficiency of quantum error mitigation and quantum error correction techniques comprises building a model of a quantum gate set that accounts for state preparation and measurement (SPAM) errors and gate errors by running learning circuits at different depths with different initial states and measurements to extract information about a quantum system. The method further comprises applying a gauge transformation to the quantum gate set to transform both the SPAM errors and the gate errors together.

In this manner, the accuracy and efficiency of quantum error mitigation/correction techniques are improved by improving the accuracy of the learned noise model and reducing the sampling overhead of the quantum error mitigation/correction techniques to achieve the desired level of accuracy.

Furthermore, in one embodiment of the present disclosure, the method additionally comprises tailoring one of a quantum error mitigation technique and a quantum error correction technique to avoid interpreting the SPAM errors and the gate errors inconsistently using the transformed SPAM errors and gate errors.

In this manner, fewer additional circuit runs are required for accurate estimations which significantly reduces the computational overhead associated with quantum error mitigation/correction.

Additionally, in one embodiment of the present disclosure, the learning circuits comprise depth-1 circuits where all quantum gates are applied in a single layer.

In this manner, the execution time of the quantum computer is improved as the execution time is directly related to the circuit's depth.

Furthermore, in one embodiment of the present disclosure, the method additionally comprises selecting an optimization objective based on one of a quantum error mitigation technique and a quantum error correction technique to be implemented. The method further comprises optimizing gauge parameters based on the optimization objective.

In this manner, the objective function is tailored to best leverage the specific error mitigation/correction strategy and minimize its limitations thereby leading to more accurate results on a noisy quantum computer.

Additionally, in one embodiment of the present disclosure, the method further comprises applying the gauge transformation using the optimized gauge parameters to the quantum gate set to transform both the SPAM errors and the gate errors together.

In this manner, a unitary transformation can be applied to all the states and gates in a quantum circuit without changing the measurement probabilities thereby allowing the representation of the errors in the quantum system to be manipulated.

Furthermore, in one embodiment of the present disclosure, the method additionally comprises applying the built model to a decoding technique.

In this manner, the decoding technique can be improved by minimizing the logical error rate per syndrome round.

Additionally, in one embodiment of the present disclosure, the decoding technique minimizes a logical error rate per syndrome round.

In this manner, the decoding technique can be improved by minimizing the logical error rate per syndrome round.

Other forms of the embodiments of the method described above are in a system and in a computer program product.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates.

As a result, quantum error mitigation and quantum error correction techniques have been developed. Quantum error mitigation refers to mitigating computation errors while keeping the hardware load to a minimum. That is, quantum error mitigation is a technique that reduces the effects of noise and errors on measured observables. Quantum error correction refers to a set of techniques used in quantum computing to protect quantum information stored in qubits from errors caused by noise and decoherence by encoding information across multiple physical qubits to detect and correct errors that may occur during computation.

Such techniques involve learning the noise of the quantum computer so that accuracy can be improved albeit at the expense of a longer experimental runtime. By learning the noise of the quantum computer, the noise present in the quantum computer can be understood and characterized, where such knowledge is utilized for designing strategies for detecting and correcting or mitigating errors that arise from that noise.

Unfortunately, there are inaccuracies in the learned noise model, such as due to state preparation and measurement (SPAM) errors and gate errors which can significantly impact the estimated noise characteristics. SPAM errors are additional noise sources that occur during the preparation of a quantum state and the measurement process, which can mask or distort the underlying gate errors, leading to misleading noise model estimations.

Currently, techniques to mitigate SPAM and gate errors use assumptions that introduce biases in quantum error mitigation/correction thereby reducing the accuracy of such techniques. Furthermore, due to such biases, the quantum error mitigation/correction techniques need to take more measurements (samples) to achieve the desired level of accuracy which significantly increases the overall runtime of the techniques. As a result of such biases and sampling overhead, the accuracy and efficiency of quantum error mitigation/correction techniques are negatively impacted.

The embodiments of the present disclosure provide the means for improving the accuracy and efficiency of quantum error mitigation/correction techniques by improving the accuracy of the learned noise model and reducing the sampling overhead of the quantum error mitigation/correction techniques to achieve the desired level of accuracy. In one embodiment, such an improvement to the accuracy and efficiency of quantum error mitigation/correction techniques is achieved by building a model (e.g., noise model) of a quantum gate set (collection of quantum gates) that accounts for SPAM and gate errors by running learning circuits at different depths with different initial states and measurements to extract information about the quantum system. Learning circuits, as used herein, refer to quantum circuits designed specifically to extract information about the quantum circuit by applying a sequence of gates with different configurations allowing for a more comprehensive analysis of errors. By using learning circuits with varying numbers of gates, the accumulation of errors can be studied thereby enabling the isolation of the effects of gate errors from SPAM errors. State preparation and measurement (SPAM) errors, as used herein, refer to inaccuracies in the process of preparing a quantum state and measuring its outcome, which are a significant source of noise in quantum computers. By preparing the quantum system in different initial states and performing measurements in different bases, a more complete information about the quantum system's behavior and potential errors can be gathered. As a result, such an approach creates a detailed model of a quantum gate set (collection of quantum gates) that not only captures the intrinsic errors of the gates themselves but also incorporates the effects of SPAM errors providing a more realistic representation of the quantum system's behavior. A gauge transformation is then applied to the quantum gate set to transform the SPAM and gate errors together. A gauge transformation, as used herein, refers to a specific mathematical operation that changes the representation of the quantum system without altering its physical observables. That is, a gauge transformation enables a different perspective of the quantum system while still preserving the underlying physics. By handling both error types (e.g., SPAM and gate errors) simultaneously, the gauge transformation can identify and correct patterns of errors that might be interpreted inconsistently or incompatibly if treated individually leading to a more comprehensive error mitigation/correction strategy. A quantum error mitigation/correction technique is then tailored to avoid interpreting errors (e.g., SPAM errors, gate errors) inconsistently if treated individually using the transformed SPAM and gate errors thereby requiring fewer additional circuit runs for accurate estimations which significantly reduces the computational overhead associated with quantum error mitigation/correction. In this manner, the accuracy and efficiency of quantum error mitigation/correction techniques are improved by improving the accuracy of the learned noise model and reducing the sampling overhead of the quantum error mitigation/correction techniques to achieve the desired level of accuracy. These and other features will be discussed in further detail below.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

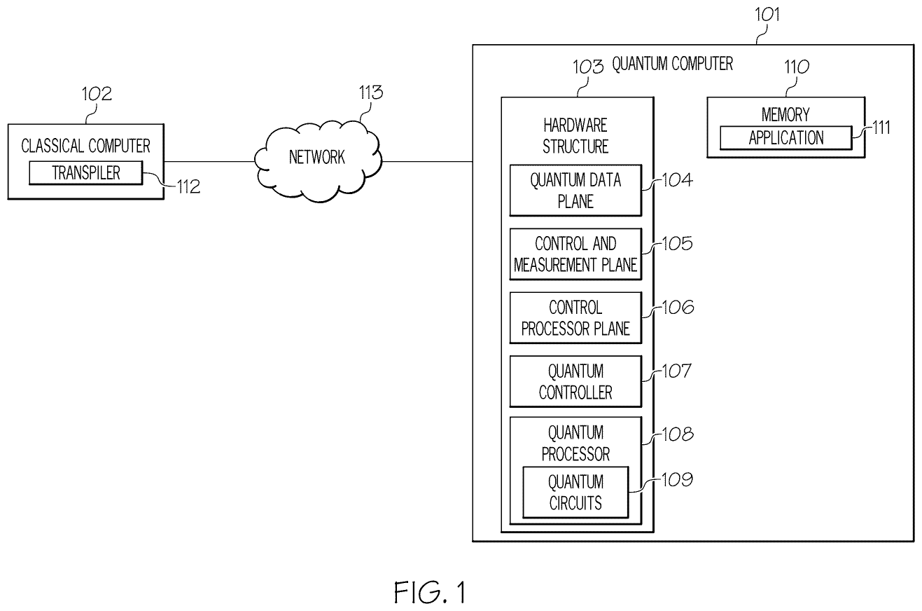

Referring now to the Figures in detail, FIG. 1 illustrates an embodiment of the present disclosure of a communication system 100 for practicing the principles of the present disclosure.

Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to improve the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks.

In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (also identified as Rx) (performs e^{iθX/2}, which corresponds to a rotation of the qubit state around the X-axis by the given angle theta θ on the Bloch sphere), RY (also identified as Ry) (performs e^{iθX/2}, which corresponds to a rotation of the qubit state around the Y-axis by the given angle theta θ on the Bloch sphere), RXX (performs the operation e^{(-iθx⊗x/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

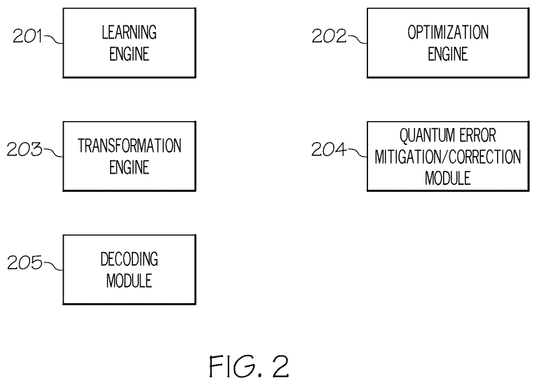

In one embodiment, memory 110 stores an application 111 that may be configured to implement one or more of the methods described herein in accordance with one or more embodiments. For example, application 111 may implement a program for improving the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors as discussed further below in connection with FIGS. 2-5 and 7. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network, and various combinations thereof, etc. Other networks, whose descriptions are omitted here for brevity, may also be used in conjunction with system 100 of FIG. 1 without departing from the scope of the present disclosure.

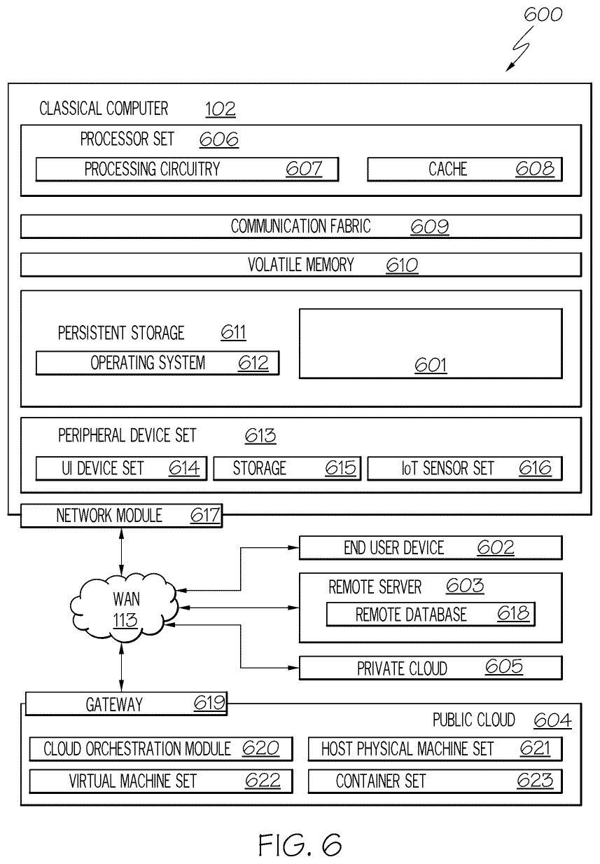

Furthermore, classical computer 102 is configured to improve the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors as discussed further below in connection with FIGS. 2-5 and 7. A description of the software components of classical computer 102 is provided below in connection with FIG. 2 and a description of the hardware configuration of classical computer 102 is provided further below in connection with FIG. 6.

System 100 is not to be limited in scope to any one particular network architecture. System 100 may include any number of quantum computers 101, classical computers 102, and networks 113.

A discussion regarding the software components used by classical computer 102 for improving the accuracy and efficiency of a quantum error mitigation/correction technique is provided below in connection with FIG. 2.

FIG. 2 is a diagram of the software components of classical computer 102 (FIG. 1) for improving the accuracy and efficiency of a quantum error mitigation/correction technique by tailoring the technique to avoid interpreting errors (e.g., SPAM errors, gate errors, etc.) inconsistently if treated individually by applying a gauge transformation to a model of a quantum gate set that accounts for SPAM and gate errors in accordance with an embodiment of the present disclosure. *

Referring to FIG. 2, in conjunction with FIG. 1, classical computer 102 includes learning engine 201 configured to build a model (noise model) of a quantum gate set (collection of gates) that accounts for SPAM and gate errors by running learning circuits at different depths with different initial states and measurements to extract information about the quantum system. Learning circuits, as used herein, refer to quantum circuits (e.g., quantum circuits 109) designed specifically to extract information about the quantum circuit by applying a sequence of gates with different configurations allowing for a more comprehensive analysis of errors. By using learning circuits with varying numbers of gates, the accumulation of errors can be studied thereby enabling the isolation of the effects of gate errors from SPAM errors. State preparation and measurement (SPAM) errors, as used herein, refer to inaccuracies in the process of preparing a quantum state and measuring its outcome, which are a significant source of noise in quantum computers. By preparing the quantum system in different initial states and performing measurements in different bases, a more complete information about the quantum system's behavior and potential errors can be gathered. As a result, such an approach creates a detailed model of a quantum gate set (collection of quantum gates) that not only captures the intrinsic errors of the gates themselves but also incorporates the effects of SPAM errors providing a more realistic representation of the quantum system's behavior. In this manner, the accuracy and efficiency of quantum error mitigation/correction techniques are improved by improving the accuracy of the learned noise model.

In one embodiment, learning engine 201 builds a model (noise model) of a quantum gate set (collection of gates) that accounts for SPAM and gate errors by running learning circuits at varying depths, initial states, and measurement patterns and analyzing the resulting data to extract information about the quantum circuit's error characteristics, particularly related to the state preparation and measurement fidelity.

In one embodiment, the learning circuits are designed with varying depths (number of gate layers) to assess how errors accumulate with increasing circuit complexity. In one embodiment, learning circuits at depth-1 are utilized which allows for significantly faster computation on a quantum computer (e.g., quantum computer 101) as the execution time is directly related to the circuit's depth. A depth-1 learning circuit, as used herein, refers to a quantum circuit with only one layer of gates.

In one embodiment, learning engine 201 explores different initial states for the qubits, including superposition states created using Hadamard gates to cover a wider range of error scenarios.

In one embodiment, learning engine 201 implements different measurement strategies, such as single-qubit measurements, multi-qubit joint measurements, and different basis rotations before measurement to capture diverse error patterns.

In one embodiment, learning engine 201 uses a quantum circuit simulator to execute the learning circuits capturing the output probabilities for each possible measurement outcome. In one embodiment, learning engine 201 incorporates a SPAM error model into the quantum circuit simulator, which could involve adding random Pauli errors with probabilities representing the estimated SPAM error rates for the quantum system. In one embodiment, learning engine 201 repeats the simulations with different circuit configurations, initial states, and measurement patterns to gather a comprehensive dataset.

In one embodiment, learning engine 201 computes the fidelity between the ideal quantum state and the simulated state for each circuit run to quantify the impact of SPAM errors. In one embodiment, learning engine 201 analyzes the fidelity data to identify patterns related to circuit depth, initial state, and measurement basis to estimate the specific SPAM error rates for state preparation and measurement processes.

In one embodiment, learning engine 201 utilizes various software tools and platforms for building a model of a quantum gate set (collection of gates) that accounts for SPAM and gate errors as discussed above, including, but not limited to, Qiskit®, Microsoft® Azure® Quantum, etc.

In one embodiment, learning engine 201 builds and trains a model of a quantum gate set by progressively changing the number of quantum gates (layers) within the quantum circuit allowing the model to learn complex patterns at various levels of interaction between qubits.

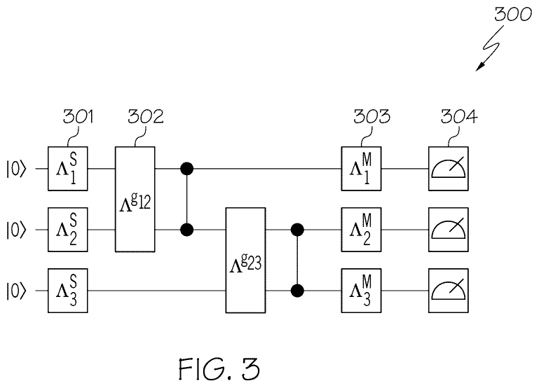

In one embodiment, the model built by learning engine 201 corresponds to a quasi-local noise model as illustrated in FIG. 3.

Referring to FIG. 3, FIG. 3 illustrates a quasi-local noise model 300 in accordance with an embodiment of the present disclosure.

Quasi-local noise model 300, as used herein, refers to a model that describes noise in a quantum system (e.g., quantum computer 101) where the errors are not strictly confined to individual qubits (fully local), but instead can exhibit some degree of spatial correlation between nearby qubits.

As shown in FIG. 3, quasi-local noise model 300 includes a representation of the quantum state errors 301, a representation of the gate errors 302, and a representation of the measurement errors 303, where measurements of the states of the qubits are performed by meters 304, where

$$Λ ( ρ ) = {Σ}_{a} {λ}_{a} {P}_{a} Tr [ {P}_{a} ρ ]$$

$${x}_{a} = - Log ( {λ}_{a \vert} )$$

$$A \vec{x} = \vec{b}$$

where [symbol] is a vector of observables used to invert the full, column-rank design matrix A for recovering the vector of model parameters [symbol] .

Referring to FIG. 2, classical computer 102 includes optimization engine 202 for selecting an optimization objective based on the quantum error mitigation/correction technique to be implemented. For example, different quantum error mitigation/correction techniques have varying strengths and weaknesses in how they handle noise. As a result, the objective function needs to be tailored to best leverage the specific error mitigation/correction strategy and minimize its limitations thereby leading to more accurate results on a noisy quantum computer.

In one embodiment, optimization engine 202 considers overhead in selecting the optimization objective. For example, some quantum error mitigation/correction techniques introduce significant computational overhead so the objective function needs to prioritize minimizing this overhead while still achieving adequate accuracy.

Examples of selecting an optimization objective include the following. When using techniques, such as the Richardson extrapolation for error mitigation, the optimization objective might focus on minimizing the variance of the estimated quantity across different noisy circuit runs to help improve the accuracy of the extrapolated result. For probabilistic error cancellation, the objective function might prioritize selecting the appropriate probability distribution for sampling noisy circuits to effectively cancel out errors.

In another example,

$$γ = exp ( {Σ}_{k} 2 {λ}_{k} )$$

where γ corresponds to the overhead scaling factor needed for performing probabilistic error cancellation. In order to minimize the overhead for performing probabilistic error cancellation, the minimization function shown below is performed.

$${min}_{η} γ ≡ {min}_{η} ( {Σ}_{k} max ( \vec{0} , {M}_{λ} ( \vec{x} + {M}_{gauge} \vec{η} ) )$$

which sums over all λₖ and enforces that each must be greater than 0. It is noted that each λₖ is an element in a vector resulting from [symbol] that is perturbed by a gauge vector M_{λ} [symbol] . Amore detailed discussion regarding the gauge vector is provided further below in connection with the discussion of applying a gauge transformation. It is noted that depending on the application (e.g., quantum error mitigation technique, quantum error correction technique), the optimization function shown above can be modified accordingly.

Optimization engine 202 utilizes various software tools and platforms for selecting an optimization objective based on the quantum error mitigation/correction technique to be implemented including, but not limited to, Mitiq, Braket®, PennyLane®, etc.

Furthermore, in one embodiment, optimization engine 202 optimizes the gauge parameters based on the optimization objective, where such optimized gauge parameters are used in applying the gauge transformation as discussed further below.

A gauge transformation, as used herein, refers to a specific mathematical operation that changes the representation of the quantum system without altering its physical observables. That is, a gauge transformation enables a different perspective of the quantum system while still preserving the underlying physics. Gauge parameters, as used herein, refer to a set of freely adjustable functions or values that define how a quantum system's wavefunction is transformed under a gauge transformation thereby allowing the representation of the quantum system (e.g., quantum computer 101) to change without altering the underlying physical observables.

In one embodiment, the gauge parameters correspond to parameters of a local, or generalized, quantum depolarizing channel (a model for quantum noise in quantum systems) associated with the sets of, or all, the qubits involved in the quantum circuit.

An example of optimizing the gauge parameters based on an optimization objective includes optimizing the gauge parameters to minimize the resource overhead for quantum error mitigation/correction.

Optimization engine 202 utilizes various software tools and platforms for optimizing the gauge parameters based on the optimization objective including, but not limited to, Mitiq, Braket®, PennyLane®, etc.

Classical computer 102 additionally include transformation engine 203 configured to apply the gauge transformation using the optimized gauge parameters to the quantum gate set to transform both the SPAM errors and the gate errors together. By handling both error types (e.g., SPAM and gate errors) simultaneously, the gauge transformation can identify and correct patterns of errors that might be interpreted inconsistently or incompatibly if treated individually leading to a more comprehensive error mitigation/correction strategy. Furthermore, the gauge transformation can reveal hidden relationships between the different error types allowing for better error detection and correction mechanisms.

Furthermore, in one embodiment, transformation engine 203 identifies the gauge freedom (ability to choose different mathematical descriptions of a physical system without changing the physical situation), where a unitary transformation can be applied to all the states and gates in a quantum circuit without changing the measurement probabilities. Such a freedom allows the representation of the errors in the quantum system to be manipulated.

In one embodiment, transformation engine 203 selects a gauge transformation (a specific unitary operation) designed to minimize the impact of non-SPAM errors while maximizing the visibility of SPAM errors. As a result, the underlying gate errors may be analyzed more accurately.

In one embodiment, transformation engine 203 applies the gauge transformation to transform the gates, such as applying the optimized gauge transformation to the gates in the quantum circuit thereby effectively changing the representation of the errors.

Furthermore, in one embodiment, transformation engine 203 transforms the initial and final states by applying the gauge transformation to the initial state and measurement operators.

An example of applying a gauge transformation involving probabilistic error cancellation is discussed below in connection with the following equation.

$$\vec{x} \to \vec{x} + {M}_{gauge} \vec{η}$$

where [symbol] is a vector of gauge parameters in a depolarizing group such that the vector of observables, [symbol] , remains unchanged. M_{gauge} is a matrix which converts the gauge parameters into a gauge vector.

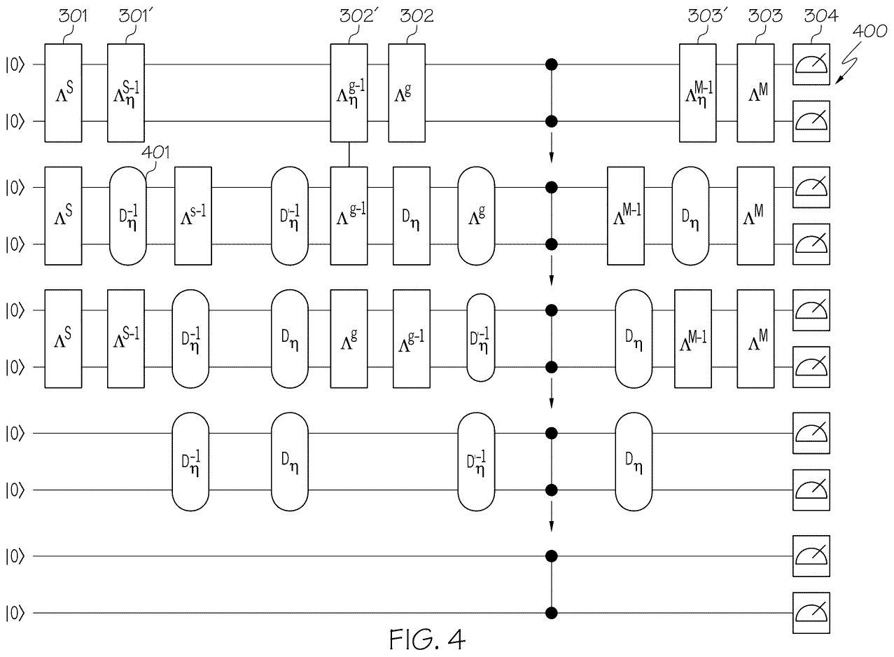

Referring to FIG. 4, FIG. 4 illustrates applying a gauge transformation using the optimized gauge parameters involving probabilistic error cancellation in accordance with an embodiment of the present disclosure.

As illustrated in FIG. 4, the gauge transformation is applied to transform the gates, such as applying the optimized gauge transformation to the gates in quantum circuit 400 thereby effectively changing the representation of the gate errors as illustrated by element 302′. Furthermore, the gauge transformation transforms the initial and final states by applying the gauge transformation to the initial state and measurement operators as illustrated by elements 301′ and 303′. Furthermore, element 401 represents the particular representation of the quantum system for which the gauge transformation is being applied.

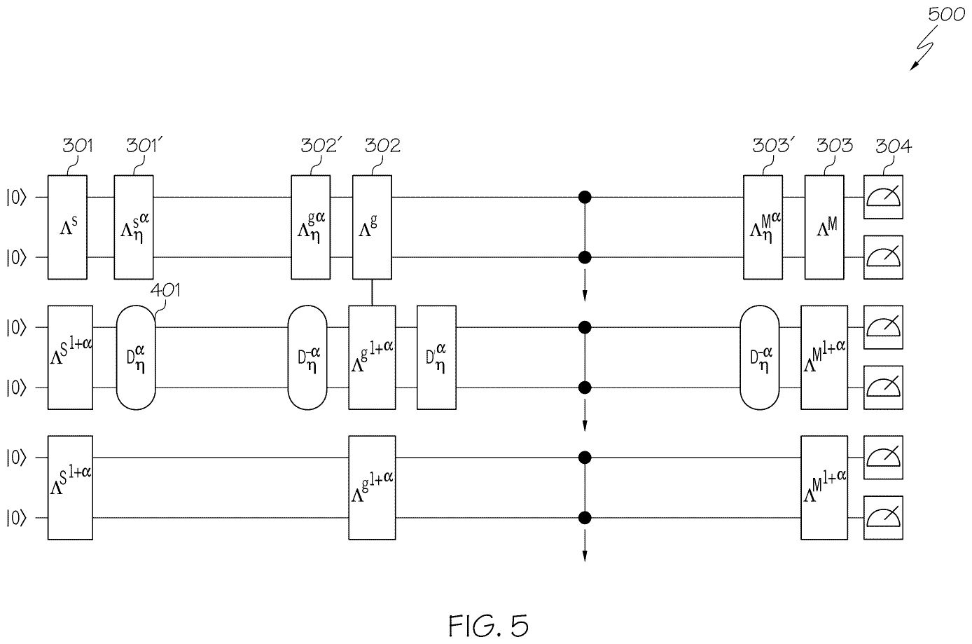

Referring now to FIG. 5, FIG. 5 illustrates applying a gauge transformation using the optimized gauge parameters involving zero-noise extrapolation in accordance with an embodiment of the present disclosure.

As illustrated in FIG. 5, the gauge transformation is applied to transform the gates, such as applying the optimized gauge transformation to the gates in quantum circuit 500 thereby effectively changing the representation of the gate errors as illustrated by element 302′. Furthermore, the gauge transformation transforms the initial and final states by applying the gauge transformation to the initial state and measurement operators as illustrated by elements 301′ and 303′. Furthermore, element 401 represents the particular representation of the quantum system for which the gauge transformation is being applied.

It is noted that the embodiment of FIG. 5 may also be applied to probabilistic error amplification.

Transformation engine 203 utilizes various software tools and platforms for applying the gauge transformation using the optimized gauge parameters to the quantum gate set to transform both the SPAM errors and the gate errors together, including, but not limited to, Qiskit®, Cirq®, etc.

Returning to FIG. 2, classical computer 102 further includes quantum error mitigation/correction module 204 configured to tailor a quantum error mitigation/correction technique to avoid interpreting the SPAM errors and the gate errors inconsistently using the transformed SPAM and gate errors thereby requiring fewer additional circuit runs for accurate estimations which significantly reduces the computational overhead associated with quantum error mitigation/correction. In this manner, the accuracy and efficiency of quantum error mitigation/correction techniques are improved by reducing the sampling overhead of the quantum error mitigation/correction techniques to achieve the desired level of accuracy.

In one embodiment, the quantum error mitigation/correction technique is tailored to avoid interpreting errors (e.g., SPAM errors, gate errors) inconsistently if treated individually using the applied gauge transformation by analyzing the transformed gate set. In one embodiment, quantum error mitigation/correction module 204 compares the transformed gate set to an ideal gate set focusing on the deviations that may be primarily related to SPAM errors. By analyzing the deviations, quantitative information about the errors (e.g., SPAM errors), such as the error probabilities associated with state preparing and measurement, are extracted.

By analyzing the results after applying a gauge transformation, the true nature of the gate errors is better understood as the gauge transformation has effectively removed some of the noise introduced by the SPAM errors. The quantum error mitigation/correction technique is then tailored by quantum error mitigation/correction module 204 to avoid interpreting errors (e.g., SPAM errors, gate errors) inconsistently if treated individually using such an analysis.

An example of a quantum error mitigation technique is the zero noise extrapolation technique. Zero noise extrapolation, as used herein, is a technique used in quantum computing to estimate the result of a quantum computation without noise by running the computation at different levels of added noise and then extrapolating the results to the “zero-noise” limit, effectively mitigating errors caused by the inherent noise in a quantum system.

Another example of a quantum error mitigation technique is the probabilistic error amplification. Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Examples of a quantum error correction technique include the Shor code and the surface code, which are both designed to detect and correct errors, such as bit-flip and phase-flip errors, by distributing quantum information across multiple physical qubits allowing for error identification and correction through syndrome measurements.

Quantum error mitigation/correction module 204 utilizes various software tools for performing quantum error mitigation/correction in the manner discussed above, including, but not limited to, Mitiq, Qiskit®, Cirq®, PyQuil®, etc.

Furthermore, classical computer 102 include decoding module 205 configured to apply the built model (noise model) to a decoding technique, such as the maximum likelihood estimation (MLE) technique, which refers to a technique where the most likely error that occurred during quantum computation is identified by calculating the probability of each possible error given the observed measurement results.

In one embodiment, decoding module 205 applies the built model to a decoding technique to improve or minimize the logical error rates per syndrome round (a single iteration of a measurement process where the quantum system is checked for errors by measuring specific auxiliary qubits (called “ancilla qubits”) that reveal information about the location and type of errors occurring on the data qubits without disturbing the actual quantum information itself).

Decoding module 205 utilizes various software tools for applying the built model (noise model) to a decoding technique including, but not limited to, Qiskit®, Azure® Quantum, etc.

In this manner, the accuracy of the learned noise model is improved and the sampling overhead of the quantum error mitigation/correction techniques is reduced to achieve the desired level of accuracy thereby improving the accuracy and efficiency of quantum error mitigation/correction techniques.

A further description of these and other functions is provided below in connection with the discussion of the method for improving the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors.

Prior to the discussion of the method for improving the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors, a description of the hardware configuration of classical computer 102 (FIG. 1) is provided below in connection with FIG. 6.

Referring now to FIG. 6, in conjunction with FIG. 1, FIG. 6 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code 601 involved in performing the inventive methods, such as improving the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors. In addition to block 601, computing environment 600 includes, for example, classical computer 102, network 113, such as a wide area network (WAN), end user device (EUD) 602, remote server 603, public cloud 604, and private cloud 605. In this embodiment, classical computer 102 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically classical computer 102, to keep the presentation as simple as possible. Classical computer 102 may be located in a cloud, even though it is not shown in a cloud in FIG. 6. On the other hand, classical computer 102 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto classical computer 102 to cause a series of operational steps to be performed by processor set 606 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 610 is located in a single package and is internal to classical computer 102, but, alternatively or additionally, the volatile memory may be distributed over multiple packages and/or located externally with respect to classical computer 102.

Persistent Storage 611 is any form of non-volatile storage for computers that is now known or to be developed in the future. The non-volatility of this storage means that the stored data is maintained regardless of whether power is being supplied to classical computer 102 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows classical computer 102 to communicate with other computers through WAN 113. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to classical computer 102 from an external computer or external storage device through a network adapter card or network interface included in network module 617.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates classical computer 102), and may take any of the forms discussed above in connection with classical computer 102. EUD 602 typically receives helpful and useful data from the operations of classical computer 102. For example, in a hypothetical case where classical computer 102 is designed to provide a recommendation to an end user, this recommendation would typically be communicated from network module 617 of classical computer 102 through WAN 113 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to classical computer 102. Remote server 603 may be controlled and used by the same entity that operates classical computer 102. Remote server 603 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620.

The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2-5 to improve the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for improving the accuracy and efficiency of a quantum error mitigation/correction technique by tailoring the technique to avoid interpreting errors (e.g., SPAM, gate errors, etc.) inconsistently if treated individually by applying a gauge transformation to a model of a quantum gate set that accounts for SPAM and gate errors, may be embodied in an application-specific integrated circuit.

As stated above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation and quantum error correction techniques have been developed. Quantum error mitigation refers to mitigating computation errors while keeping the hardware load to a minimum. That is, quantum error mitigation is a technique that reduces the effects of noise and errors on measured observables. Quantum error correction refers to a set of techniques used in quantum computing to protect quantum information stored in qubits from errors caused by noise and decoherence by encoding information across multiple physical qubits to detect and correct errors that may occur during computation. Such techniques involve learning the noise of the quantum computer so that accuracy can be improved albeit at the expense of a longer experimental runtime. By learning the noise of the quantum computer, the noise present in the quantum computer can be understood and characterized, where such knowledge is utilized for designing strategies for detecting and correcting or mitigating errors that arise from that noise. Unfortunately, there are inaccuracies in the learned noise model, such as due to state preparation and measurement (SPAM) errors which can significantly impact the estimated noise characteristics. SPAM errors are additional noise sources that occur during the preparation of a quantum state and the measurement process, which can mask or distort the underlying gate errors, leading to misleading noise model estimations. Currently, techniques to mitigate SPAM and gate errors use assumptions that introduce biases in quantum error mitigation/correction thereby reducing the accuracy of such techniques. Furthermore, due to such biases, the quantum error mitigation/correction techniques need to take more measurements (samples) to achieve the desired level of accuracy which significantly increases the overall runtime of the techniques. As a result of such biases and sampling overhead, the accuracy and efficiency of quantum error mitigation/correction techniques are negatively impacted.

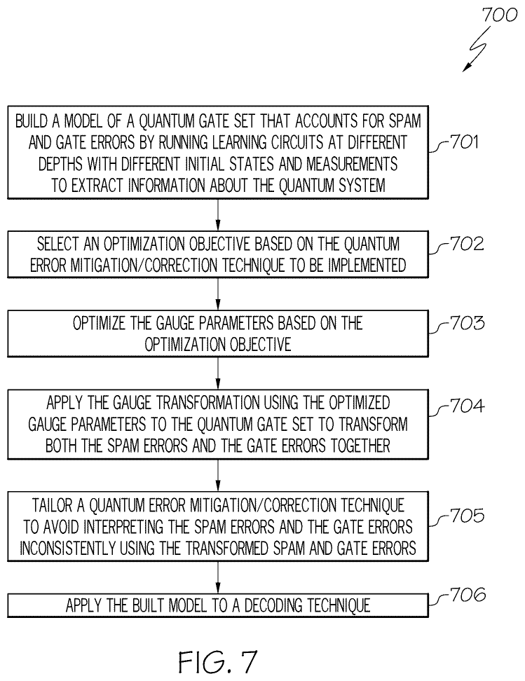

The embodiments of the present disclosure provide the means for improving the accuracy and efficiency of quantum error mitigation/correction techniques by improving the accuracy of the learned noise model and reducing the sampling overhead of the quantum error mitigation/correction techniques to achieve the desired level of accuracy as discussed below in connection with FIG. 7.

FIG. 7 is a flowchart of a method 700 for improving the accuracy and efficiency of a quantum error mitigation/correction technique by tailoring the technique to avoid interpreting errors (e.g., SPAM errors, gate errors, etc.) inconsistently if treated individually by applying a gauge transformation to a model of a quantum gate set that accounts for SPAM and gate errors in accordance with an embodiment of the present disclosure.

Referring to FIG. 7, in conjunction with FIGS. 1-6, in step 701, learning engine 201 builds a model (noise model) of a quantum gate set (collection of gates) that accounts for SPAM and gate errors by running learning circuits at different depths with different initial states and measurements to extract information about the quantum system.

As stated above, learning circuits, as used herein, refer to quantum circuits (e.g., quantum circuits 109) designed specifically to extract information about the quantum circuit by applying a sequence of gates with different configurations allowing for a more comprehensive analysis of errors. By using learning circuits with varying numbers of gates, the accumulation of errors can be studied thereby enabling the isolation of the effects of gate errors from SPAM errors. State preparation and measurement (SPAM) errors, as used herein, refer to inaccuracies in the process of preparing a quantum state and measuring its outcome, which are a significant source of noise in quantum computers. By preparing the quantum system in different initial states and performing measurements in different bases, a more complete information about the quantum system's behavior and potential errors can be gathered. As a result, such an approach creates a detailed model of a quantum gate set (collection of quantum gates) that not only captures the intrinsic errors of the gates themselves but also incorporates the effects of SPAM errors providing a more realistic representation of the quantum system's behavior. In this manner, the accuracy and efficiency of quantum error mitigation/correction techniques are improved by improving the accuracy of the learned noise model.

In one embodiment, learning engine 201 builds a model (noise model) of a quantum gate set (collection of gates) that accounts for SPAM and gate errors by running learning circuits at varying depths, initial states, and measurement patterns and analyzing the resulting data to extract information about the quantum circuit's error characteristics, particularly related to the state preparation and measurement fidelity.

In one embodiment, the learning circuits are designed with varying depths (number of gate layers) to assess how errors accumulate with increasing circuit complexity. In one embodiment, learning circuits at depth-1 are utilized which allows for significantly faster computation on a quantum computer (e.g., quantum computer 101) as the execution time is directly related to the circuit's depth. A depth-1 learning circuit, as used herein, refers to a quantum circuit with only one layer of gates.

In one embodiment, learning engine 201 explores different initial states for the qubits, including superposition states created using Hadamard gates to cover a wider range of error scenarios.

In one embodiment, learning engine 201 implements different measurement strategies, such as single-qubit measurements, multi-qubit joint measurements, and different basis rotations before measurement to capture diverse error patterns.

In one embodiment, learning engine 201 uses a quantum circuit simulator to execute the learning circuits capturing the output probabilities for each possible measurement outcome. In one embodiment, learning engine 201 incorporates a SPAM error model into the quantum circuit simulator, which could involve adding random Pauli errors with probabilities representing the estimated SPAM error rates for the quantum system. In one embodiment, learning engine 201 repeats the simulations with different circuit configurations, initial states, and measurement patterns to gather a comprehensive dataset.

In one embodiment, learning engine 201 computes the fidelity between the ideal quantum state and the simulated state for each circuit run to quantify the impact of SPAM errors. In one embodiment, learning engine 201 analyzes the fidelity data to identify patterns related to circuit depth, initial state, and measurement basis to estimate the specific SPAM error rates for state preparation and measurement processes.

In one embodiment, learning engine 201 utilizes various software tools and platforms for building a model of a quantum gate set (collection of gates) that accounts for SPAM and gate errors as discussed above, including, but not limited to, Qiskit®, Microsoft® Azure® Quantum, etc.

In one embodiment, learning engine 201 builds and trains a model of a quantum gate set by progressively changing the number of quantum gates (layers) within the quantum circuit allowing the model to learn complex patterns at various levels of interaction between qubits.

In one embodiment, the model built by learning engine 201 corresponds to a quasi-local noise model as illustrated in FIG. 3.

As shown in FIG. 3, quasi-local noise model 300 includes a representation of the quantum state errors 301, a representation of the gate errors 302, and a representation of the measurement errors 303, where measurements of the states of the qubits are performed by meters 304, where

$$Λ ( ρ ) = {Σ}_{a} {λ}_{a} {P}_{a} Tr [ {P}_{a} ρ ]$$

$${x}_{a} = - Log ( {λ}_{α \vert} )$$

$$A \vec{x} = \vec{b}$$

where [symbol] is a vector of observables used to invert the full, column-rank design matrix A for recovering the vector of model parameters [symbol] .

In step 702, optimization engine 202 selects an optimization objective based on the quantum error mitigation/correction technique to be implemented.

As discussed above, for example, different quantum error mitigation/correction techniques have varying strengths and weaknesses in how they handle noise. As a result, the objective function needs to be tailored to best leverage the specific error mitigation/correction strategy and minimize its limitations thereby leading to more accurate results on a noisy quantum computer.

In one embodiment, optimization engine 202 considers overhead in selecting the optimization objective. For example, some quantum error mitigation/correction techniques introduce significant computational overhead so the objective function needs to prioritize minimizing this overhead while still achieving adequate accuracy.

Examples of selecting an optimization objective include the following. When using techniques, such as the Richardson extrapolation for error mitigation, the optimization objective might focus on minimizing the variance of the estimated quantity across different noisy circuit runs to help improve the accuracy of the extrapolated result. For probabilistic error cancellation, the objective function might prioritize selecting the appropriate probability distribution for sampling noisy circuits to effectively cancel out errors.

In another example,

$$γ = exp ( {Σ}_{k} 2 {λ}_{k} )$$

where γ corresponds to the overhead scaling factor needed for performing probabilistic error cancellation. In order to minimize the overhead for performing probabilistic error cancellation, the minimization function shown below is performed.

$${min}_{η} γ ≡ {min}_{η} ( {Σ}_{k} max ( \vec{0} , {M}_{λ} ( \vec{x} + {M}_{gauge} \vec{η} ) )$$

which sums over all λₖ and enforces that each must be greater than 0. It is noted that each λₖ is an element in a vector resulting from [symbol] that is perturbed by a gauge vector M_{λ} [symbol] . It is noted that depending on the application (e.g., quantum error mitigation technique, quantum error correction technique), the optimization function shown above can be modified accordingly.

Optimization engine 202 utilizes various software tools and platforms for selecting an optimization objective based on the quantum error mitigation/correction technique to be implemented including, but not limited to, Mitiq, Braket®, PennyLane®, etc.

In step 703, optimization engine 202 optimizes the gauge parameters based on the optimization objective, where such optimized gauge parameters are used in applying the gauge transformation.

As stated above, a gauge transformation, as used herein, refers to a specific mathematical operation that changes the representation of the quantum system without altering its physical observables. That is, a gauge transformation enables a different perspective of the quantum system while still preserving the underlying physics. Gauge parameters, as used herein, refer to a set of freely adjustable functions or values that define how a quantum system's wavefunction is transformed under a gauge transformation thereby allowing the representation of the quantum system (e.g., quantum computer 101) to change without altering the underlying physical observables.

In one embodiment, the gauge parameters correspond to parameters of a local, or generalized, quantum depolarizing channel (a model for quantum noise in quantum systems) associated with the sets of, or all, the qubits involved in the quantum circuit.

An example of optimizing the gauge parameters based on an optimization objective includes optimizing the gauge parameters to minimize the resource overhead for quantum error mitigation/correction.

Optimization engine 202 utilizes various software tools and platforms for optimizing the gauge parameters based on the optimization objective including, but not limited to, Mitiq, Braket®, PennyLane®, etc.

In step 704, transformation engine 203 applies the gauge transformation using the optimized gauge parameters to the quantum gate set to transform both the SPAM errors and the gate errors together.

As discussed above, by handling both error types (e.g., SPAM and gate errors) simultaneously, the gauge transformation can identify and correct patterns of errors that might be interpreted inconsistently or incompatibly if treated individually leading to a more comprehensive error mitigation/correction strategy. Furthermore, the gauge transformation can reveal hidden relationships between the different error types allowing for better error detection and correction mechanisms.

Furthermore, in one embodiment, transformation engine 203 identifies the gauge freedom (ability to choose different mathematical descriptions of a physical system without changing the physical situation), where a unitary transformation can be applied to all the states and gates in a quantum circuit without changing the measurement probabilities. Such a freedom allows the representation of the errors in the quantum system to be manipulated.

In one embodiment, transformation engine 203 selects a gauge transformation (a specific unitary operation) designed to minimize the impact of non-SPAM errors while maximizing the visibility of SPAM errors. As a result, the underlying gate errors may be analyzed more accurately.

In one embodiment, transformation engine 203 applies the gauge transformation to transform the gates, such as applying the optimized gauge transformation to the gates in the quantum circuit thereby effectively changing the representation of the errors.

Furthermore, in one embodiment, transformation engine 203 transforms the initial and final states by applying the gauge transformation to the initial state and measurement operators.

An example of applying a gauge transformation involving probabilistic error cancellation is discussed below in connection with the following equation.

$$\vec{x} \to \vec{x} + {M}_{gauge} \vec{η}$$

where [symbol] is a vector of gauge parameters in a depolarizing group such that the vector of observables, [symbol] , remains unchanged. M_{guage} is a matrix which converts the gauge parameters into a gauge vector.

Referring to FIG. 4, which illustrates applying a gauge transformation using the optimized gauge parameters involving probabilistic error cancellation, the gauge transformation is applied to transform the gates, such as applying the optimized gauge transformation to the gates in quantum circuit 400 thereby effectively changing the representation of the gate errors as illustrated by element 302′. Furthermore, the gauge transformation transforms the initial and final states by applying the gauge transformation to the initial state and measurement operators as illustrated by elements 301′ and 303′. Furthermore, element 401 represents the particular representation of the quantum system for which the gauge transformation is being applied.

Referring now to FIG. 5, which illustrates applying a gauge transformation using the optimized gauge parameters involving zero-noise extrapolation, the gauge transformation is applied to transform the gates, such as applying the optimized gauge transformation to the gates in quantum circuit 500 thereby effectively changing the representation of the gate errors as illustrated by element 302′. Furthermore, the gauge transformation transforms the initial and final states by applying the gauge transformation to the initial state and measurement operators as illustrated by elements 301′ and 303′. Furthermore, element 401 represents the particular representation of the quantum system for which the gauge transformation is being applied.

It is noted that the embodiment of FIG. 5 may also be applied to probabilistic error amplification.

Transformation engine 203 utilizes various software tools and platforms for applying the gauge transformation using the optimized gauge parameters to the quantum gate set to transform both the SPAM errors and the gate errors together, including, but not limited to, Qiskit®, Cirq®, etc.

In step 705, quantum error mitigation/correction module 204 tailors a quantum error mitigation/correction technique to avoid interpreting the SPAM errors and the gate errors inconsistently if treated individually using the transformed SPAM and gate errors thereby requiring fewer additional circuit runs for accurate estimations which significantly reduces the computational overhead associated with quantum error mitigation/correction. In this manner, the accuracy and efficiency of quantum error mitigation/correction techniques are improved by reducing the sampling overhead of the quantum error mitigation/correction techniques to achieve the desired level of accuracy.

As stated above, in one embodiment, the quantum error mitigation/correction technique is tailored to avoid interpreting errors (e.g., SPAM errors, gate errors) inconsistently if treated individually using the applied gauge transformation by analyzing the transformed gate set. In one embodiment, quantum error mitigation/correction module 204 compares the transformed gate set to an ideal gate set focusing on the deviations that may be primarily related to SPAM errors. By analyzing the deviations, quantitative information about the errors (e.g., SPAM errors), such as the error probabilities associated with state preparing and measurement, are extracted.

By analyzing the results after applying a gauge transformation, the true nature of the gate errors is better understood as the gauge transformation has effectively removed some of the noise introduced by the SPAM errors. The quantum error mitigation/correction technique is then tailored by quantum error mitigation/correction module 204 to avoid interpreting errors (e.g., SPAM errors, gate errors) inconsistently if treated individually using such an analysis.

An example of a quantum error mitigation technique is the zero noise extrapolation technique. Zero noise extrapolation, as used herein, is a technique used in quantum computing to estimate the result of a quantum computation without noise by running the computation at different levels of added noise and then extrapolating the results to the “zero-noise” limit, effectively mitigating errors caused by the inherent noise in a quantum system.

Another example of a quantum error mitigation technique is the probabilistic error amplification. Probabilistic error amplification, as used herein, is a technique which introduces controlled noise to a quantum circuit to amplify existing errors. The amplified noise data is then used in conjunction with zero noise extrapolation, where the results from different noise levels are extrapolated to estimate what the results would be in a completely noise-free scenario.

Examples of a quantum error correction technique include the Shor code and the surface code, which are both designed to detect and correct errors, such as bit-flip and phase-flip errors, by distributing quantum information across multiple physical qubits allowing for error identification and correction through syndrome measurements.

Quantum error mitigation/correction module 204 utilizes various software tools for performing quantum error mitigation/correction in the manner discussed above, including, but not limited to, Mitiq, Qiskit®, Cirq®, PyQuil®, etc.

In step 706, decoding module 205 applies the built model (noise model) to a decoding technique, such as the maximum likelihood estimation (MLE) technique, which refers to a technique where the most likely error that occurred during quantum computation is identified by calculating the probability of each possible error given the observed measurement results.

As discussed above, in one embodiment, decoding module 205 applies the built model to a decoding technique to improve or minimize the logical error rates per syndrome round (a single iteration of a measurement process where the quantum system is checked for errors by measuring specific auxiliary qubits (called “ancilla qubits”) that reveal information about the location and type of errors occurring on the data qubits without disturbing the actual quantum information itself).

Decoding module 205 utilizes various software tools for applying the built model (noise model) to a decoding technique including, but not limited to, Qiskit®, Azure® Quantum, etc.

As a result of the foregoing, the accuracy of the learned noise model is improved and the sampling overhead of the quantum error mitigation/correction techniques is reduced to achieve the desired level of accuracy thereby improving the accuracy and efficiency of quantum error mitigation/correction techniques.

Furthermore, the principles of the present disclosure improve the technology or technical field involving quantum error mitigation/correction.

As discussed above, current quantum hardware is subject to different sources of noise, the most well-known being qubit decoherence, individual gate errors, and measurement errors. These errors limit the depth of the quantum circuit (i.e., the number of “layers” of quantum gates, executed in parallel, it takes to complete the computation defined by the quantum circuit) that can be implemented. However, even for shallow circuits, noise can lead to faulty estimates. As a result, quantum error mitigation and quantum error correction techniques have been developed. Quantum error mitigation refers to mitigating computation errors while keeping the hardware load to a minimum. That is, quantum error mitigation is a technique that reduces the effects of noise and errors on measured observables. Quantum error correction refers to a set of techniques used in quantum computing to protect quantum information stored in qubits from errors caused by noise and decoherence by encoding information across multiple physical qubits to detect and correct errors that may occur during computation. Such techniques involve learning the noise of the quantum computer so that accuracy can be improved albeit at the expense of a longer experimental runtime. By learning the noise of the quantum computer, the noise present in the quantum computer can be understood and characterized, where such knowledge is utilized for designing strategies for detecting and correcting or mitigating errors that arise from that noise. Unfortunately, there are inaccuracies in the learned noise model, such as due to state preparation and measurement (SPAM) errors which can significantly impact the estimated noise characteristics. SPAM errors are additional noise sources that occur during the preparation of a quantum state and the measurement process, which can mask or distort the underlying gate errors, leading to misleading noise model estimations. Currently, techniques to mitigate SPAM and gate errors use assumptions that introduce biases in quantum error mitigation/correction thereby reducing the accuracy of such techniques. Furthermore, due to such biases, the quantum error mitigation/correction techniques need to take more measurements (samples) to achieve the desired level of accuracy which significantly increases the overall runtime of the techniques. As a result of such biases and sampling overhead, the accuracy and efficiency of quantum error mitigation/correction techniques are negatively impacted.

Embodiments of the present disclosure improve such technology by building a model (e.g., noise model) of a quantum gate set (collection of quantum gates) that accounts for SPAM and gate errors by running learning circuits at different depths with different initial states and measurements to extract information about the quantum system. Learning circuits, as used herein, refer to quantum circuits designed specifically to extract information about the quantum circuit by applying a sequence of gates with different configurations allowing for a more comprehensive analysis of errors. By using learning circuits with varying numbers of gates, the accumulation of errors can be studied thereby enabling the isolation of the effects of gate errors from SPAM errors. State preparation and measurement (SPAM) errors, as used herein, refer to inaccuracies in the process of preparing a quantum state and measuring its outcome, which are a significant source of noise in quantum computers. By preparing the quantum system in different initial states and performing measurements in different bases, a more complete information about the quantum system's behavior and potential errors can be gathered. As a result, such an approach creates a detailed model of a quantum gate set (collection of quantum gates) that not only captures the intrinsic errors of the gates themselves but also incorporates the effects of SPAM errors providing a more realistic representation of the quantum system's behavior. A gauge transformation is then applied to the quantum gate set to transform the SPAM and gate errors together. A gauge transformation, as used herein, refers to a specific mathematical operation that changes the representation of the quantum system without altering its physical observables. That is, a gauge transformation enables a different perspective of the quantum system while still preserving the underlying physics. By handling both error types (e.g., SPAM and gate errors) simultaneously, the gauge transformation can identify and correct patterns of errors that might be interpreted inconsistently or incompatibly if treated individually leading to a more comprehensive error mitigation/correction strategy. A quantum error mitigation/correction technique is then tailored to avoid interpreting errors (e.g., SPAM errors, gate errors) inconsistently if treated individually using the transformed SPAM and gate errors thereby requiring fewer additional circuit runs for accurate estimations which significantly reduces the computational overhead associated with quantum error mitigation/correction. In this manner, the accuracy and efficiency of quantum error mitigation/correction techniques are improved by improving the accuracy of the learned noise model and reducing the sampling overhead of the quantum error mitigation/correction techniques to achieve the desired level of accuracy. Furthermore, in this manner, there is an improvement in the technical field involving quantum error mitigation/correction.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for improving accuracy and efficiency of quantum error mitigation and quantum error correction techniques, the method comprising:
building a model of a quantum gate set that accounts for state preparation and measurement (SPAM) errors and gate errors by running learning circuits at different depths with different initial states and measurements to extract information about a quantum system; and
applying a gauge transformation to said quantum gate set to transform both said SPAM errors and said gate errors together.

2. The method as recited in claim 1 further comprising:
tailoring one of a quantum error mitigation technique and a quantum error correction technique to avoid interpreting said SPAM errors and said gate errors inconsistently using said transformed SPAM errors and gate errors.

3. The method as recited in claim 1, wherein said learning circuits comprise depth-1 circuits where all quantum gates are applied in a single layer.

4. The method as recited in claim 1 further comprising:
selecting an optimization objective based on one of a quantum error mitigation technique and a quantum error correction technique to be implemented; and
optimizing gauge parameters based on said optimization objective.

5. The method as recited in claim 4 further comprising:
applying said gauge transformation using said optimized gauge parameters to said quantum gate set to transform both said SPAM errors and said gate errors together.

6. The method as recited in claim 1 further comprising:
applying said built model to a decoding technique.

7. The method as recited in claim 6, wherein said decoding technique minimizes a logical error rate per syndrome round.

8. A computer program product for improving accuracy and efficiency of quantum error mitigation and quantum error correction techniques, the computer program product comprising one or more computer readable storage mediums having program code embodied therewith, the program code comprising programming instructions for:
building a model of a quantum gate set that accounts for state preparation and measurement (SPAM) errors and gate errors by running learning circuits at different depths with different initial states and measurements to extract information about a quantum system; and
applying a gauge transformation to said quantum gate set to transform both said SPAM errors and said gate errors together.

9. The computer program product as recited in claim 8, wherein the program code further comprises the programming instructions for:
tailoring one of a quantum error mitigation technique and a quantum error correction technique to avoid interpreting said SPAM errors and said gate errors inconsistently using said transformed SPAM errors and gate errors.

10. The computer program product as recited in claim 8, wherein said learning circuits comprise depth-1 circuits where all quantum gates are applied in a single layer.

11. The computer program product as recited in claim 8, wherein the program code further comprises the programming instructions for:
selecting an optimization objective based on one of a quantum error mitigation technique and a quantum error correction technique to be implemented; and
optimizing gauge parameters based on said optimization objective.

12. The computer program product as recited in claim 11, wherein the program code further comprises the programming instructions for:
applying said gauge transformation using said optimized gauge parameters to said quantum gate set to transform both said SPAM errors and said gate errors together.

13. The computer program product as recited in claim 8, wherein the program code further comprises the programming instructions for:
applying said built model to a decoding technique.

14. The computer program product as recited in claim 13, wherein said decoding technique minimizes a logical error rate per syndrome round.

15. A system, comprising:
a memory for storing a computer program for improving accuracy and efficiency of quantum error mitigation and quantum error correction techniques; and
a processor connected to said memory, wherein said processor is configured to execute program instructions of the computer program comprising:
building a model of a quantum gate set that accounts for state preparation and measurement (SPAM) errors and gate errors by running learning circuits at different depths with different initial states and measurements to extract information about a quantum system; and
applying a gauge transformation to said quantum gate set to transform both said SPAM errors and said gate errors together.

16. The system as recited in claim 15, wherein the program instructions of the computer program further comprise:
tailoring one of a quantum error mitigation technique and a quantum error correction technique to avoid interpreting said SPAM errors and said gate errors inconsistently using said transformed SPAM errors and gate errors.

17. The system as recited in claim 15, wherein said learning circuits comprise depth-1 circuits where all quantum gates are applied in a single layer.

18. The system as recited in claim 15, wherein the program instructions of the computer program further comprise:
selecting an optimization objective based on one of a quantum error mitigation technique and a quantum error correction technique to be implemented; and
optimizing gauge parameters based on said optimization objective.

19. The system as recited in claim 18, wherein the program instructions of the computer program further comprise:
applying said gauge transformation using said optimized gauge parameters to said quantum gate set to transform both said SPAM errors and said gate errors together.

20. The system as recited in claim 15, wherein the program instructions of the computer program further comprise:
applying said built model to a decoding technique.
